(19) United States
(12) Patent Application Publication
(10) Pub. No.: US 2008/0298300 A1
(43) Pub. Date: Dec. 4, 2008

(54) Communication Control Method and System for Carrying Out Said Method

(75) Inventors: Claire Mousset, Paris (FR); Mark Watson, San Francisco, CA (US)

Correspondence Address: SUGHRUE MION, PLLC, 2100 PENNSYLVANIA AVENUE, N.W., SUITE 800, WASHINGTON, DC, 20037, US

(73) Assignee: ALCATEL LUCENT, Paris (FR)

(21) Appl. No.: 11/577,991

(22) PCT Filed: Oct. 18, 2005
(86) PCT No.: PCT/EP05/11205

§ 371 Date: Sep. 27, 2007

(30) Foreign Application Priority Data
Oct. 26, 2004 (EP) 04292542.0

(51) Int. Cl. H04Q 7/00

(52) U.S. Cl. 370/328

(57) ABSTRACT

A system including communications means (3), an application server (7) and a gateway (2) between the communication means and the application server is adapted to effect communications with terminals in relation to services offered by said application server, each communication being effected via said communications means using a bearer service between a terminal and said gateway. In relation to a terminal (1) that has a communication in progress or requested according to a service offered by said application server: there are determined in the application server parameters of said service substantially corresponding to respective bearer service characteristics; the parameters that have been determined are sent to the gateway; and said communication is selectively processed in the gateway as a function of parameters that have been received.

The present invention relates to communication control.

It finds a particularly beneficial application when the communications concerned relate to varied communication services, such as voice communications, data transmission, multimedia applications, or any other application.

Prior art communication systems provide some degree of communication control. Such systems typically include means for communicating with terminals, one or more servers offering predefined communication services, and a gateway between the communication means and the server for managing communications effected via the communication means and for analyzing and/or processing service elements carried by said communications.

For example, the general packet radio service (GPRS) radio communication system provides data services for mobile radio terminals via a gateway GPRS support node (GGSN). The GGSN therefore constitutes both the last node of the radio communication system, in which it manages communications with terminals, and the first Internet Protocol (IP) router to external data networks such as the Internet or Intranet type networks.

Note that other systems can also be envisaged, such as the universal mobile telecommunication system (UMTS), wireless local area networks (WLAN), cable communication systems, etc. By way of further example, if the communication system is a WLAN, the gateway is a packet data gateway (PDG).

In some circumstances, it can be beneficial for the same terminal to manage communications in different ways, especially in a multimedia context in which the terminal is able to use varied services. One example of communication control is communication charging. Different strategies can be adopted for charging traffic depending on the service provided. For example, voice traffic is advantageously billed depending on the elapsed time, whereas data transmission is preferably billed as a function of the amount of data exchanged. Many other examples of communication control can be envisaged, such as statistical analysis of flows exchanged in relation to the various services, for example.

When a communication must be set up between a terminal and the system concerned, a bearer service is set up beforehand with the gateway referred to above. The communication then proceeds as part of that bearer service, which in particular has certain features relating to the communication media used to carry the communication within the system, for example a traffic class or, more generally, quality of service information. For example, a GGSN sets up at least one packet data protocol context (PDP context), as bearer service, for each terminal which is likely to communicate with the GPRS system.

Implementing communication control at the gateway level differently according to the bearer services that have been set up is therefore known in the art. For example, if two PDP contexts have been set up for a GPRS terminal, communications effected in each of the two PDP contexts can be controlled differently by the GGSN. In contrast, if two separate services are implemented by a terminal in the same PDP context, the corresponding two communications are then controlled in the same way by the GGSN. This makes it obligatory to have exactly the same charging mode for two services that are potentially of very different kinds, for example. Now, in most circumstances, the choice to implement a given service in one PDP context rather than another is left to the terminal, and the behavior of terminals is therefore very disparate from this point of view.

Another level of control was introduced in technical specification TS 23.125, V6.1.0, “Technical Specification Group Services and System Aspects; Overall High Level Functionality and Architecture Impacts of Flow Based Charging; Stage 2 (Release 6)”, published by the 3^{rd} Generation Partnership Project (3GPP) in June 2004. Here control is effected as a function of the flows transmitted to or from an external network. Returning to the example of the GPRS, this is reflected in the fact that the GGSN referred to above analyses the IP flows that it receives and controls them as a function of the results of its analysis. For example, if a GPRS terminal effects two communications in relation to two different services, the GGSN is informed of the characteristics of the service provided for each of the communications and controls the two communications differently. For example, the communications can be charged differently if the services provided justify this.

In the above example, the GGSN can base communication control on control rules predefined in the GGSN itself. It is equally possible to define control rules in an entity external to the GGSN. The above-cited technical specification TS 23.125 therefore provides a filtering unit called the charging rules function (CRF) which holds predefined filtering rules that it can send to the GGSN. The filtering rules enable communication identification according to the service provided. Upon reception of these filtering rules from the CRF, the GGSN can filter the various communication flows to process them selectively, i.e. in an individualized manner. For example, the filtering rules can include charging information, such as a charging key or a charging mode. The GGSN can then use these charging rules for charging the various communications.

Although there is provision for relatively fine communication control in the above-cited technical specification TS 23.125, there is no provision for differentiated control in certain circumstances. For example, if a GPRS terminal has two open PDP contexts and communicates by means of the same service (or two services having common characteristics) in each of those PDP contexts, the GGSN then receives from the CRF filtering rules to be applied without distinction to the two communications, as indicated above.

This lacks flexibility because it is an incentive to dedicate each PDP context to a given service. It can even encourage fraud, for example if a terminal user sets up a plurality of PDP contexts for use with communication services that normally have different charging rules at the CRF, in order to obtain the benefit of the most favorable charging for all its PDP contexts.

An object of the present invention is to limit the above-mentioned drawbacks by providing flexible and efficient communication control.

Another object of the invention is to control communications using services in a manner that is opportune given the characteristics of the bearer services used in the system.

Another object of the invention is to condition the opening of a bearer service on the envisaged application on that bearer service.

The invention therefore proposes a method of controlling communications in a system that includes communication means, at least one application server, and at least one gateway between the communication means and the application server, which system is adapted to effect communications with terminals in relation to services offered by said application server, and in which system each communication is effected via said communication means using a bearer service between a terminal and said gateway. The method includes the following steps in relation to at least one terminal that has at least one communication in progress, or has requested at least one communication, according to a service offered by said application server:
determining in the application server parameters of said service that substantially correspond to respective bearer service characteristics;
sending said determined parameters; and
selectively processing, in the gateway, said communication as a function of the received parameters.

Thus separate, possibly different, forms of processing can be effected on communication flows using services having common characteristics but where the bearer services between the terminal and the gateway are different.

The processing in question can be of any type. For example, in one embodiment of the invention, it comprises a step of filtering the communication flows as a function of the bearer service in which those flows are exchanged. A filter unit then advantageously delivers filtering rules to the gateway to enable such filtering. Further processing can additionally be effected, such as, for example, specific charging on the basis of charging rules.

Alternatively, the selective processing of the communications can consist in accepting or rejecting the setup of a bearer service for which the terminal has sent a setup request. The bearer service is therefore advantageously setup only if the parameters that have been determined correspond to characteristics of the bearer service to be setup.

The parameters concerned are for example a quality of service information, a class of service, a bandwidth occupied by the service, a coding/decoding mode, or a transmission delay constraint.

The bearer service characteristics to which said determined parameters substantially correspond are for example a quality of service information or a class of traffic.

The indications identifying the service for said communication either in progress or being requested can advantageously consist of some of the following information: a source IP address, a destination IP address, a source port number, a destination port number, a communication protocol identifier.

The invention also proposes an application server in a system that further includes communication means and at least one gateway between the communication means and the application server, which system is adapted to effect communications with terminals in relation to services offered by said application server, and in which system each communication being effected via said communication means using a bearer service between a terminal and said gateway, the gateway being further adapted to selectively process communications as a function of received service parameters. The application server includes, in relation to at least one terminal that has at least one communication in progress, or has requested at least one communication, according to a service offered by said application server:
means for determining parameters of said service that substantially correspond to respective bearer service characteristics; and
means for sending said determined parameters to the gateway.

The invention further proposes a gateway between communication means and at least one application server of a system adapted to effect communications with terminals in relation to services offered by said application server, each communication being effected via said communication means using a bearer service between a terminal and said gateway, the application server being adapted to determine, for each service offered, parameters that substantially correspond to respective bearer service characteristics. The gateway includes the following steps in relation to at least one terminal that has at least one communication in progress, or has requested at least one communication, according to a service offered by said application server:
means for receiving the parameters of said service that substantially correspond to respective bearer service characteristics determined by the application server; and
means for selectively processing said communication as a function of said received parameters.

The invention further proposes a filter unit in a system further including communication means, at least one application server, and at least one gateway between the communication means and the application server, the system being adapted to effect communications with terminals in relation to services offered by said application server, each communication being effected via said communication means using a bearer service between a terminal and said gateway, the application server being adapted to determine, for each service offered, parameters that substantially correspond to respective bearer service characteristics. The filter unit is connected to the gateway and to the application server and includes, in relation to at least one terminal that has at least one communication in progress, or has requested at least one communication, according to a service offered by said application server:
means for obtaining from the application server indications identifying the service for said communication in progress or requested;
means for obtaining parameters of said service that substantially correspond to respective bearer service characteristics; and
means for delivering to the gateway rules for filtering communications as a function of said obtained indications, in correspondence with said obtained parameters.

Other features and advantages of the present invention become apparent from the following description of non-limiting embodiments given with reference to the appended drawings, in which:

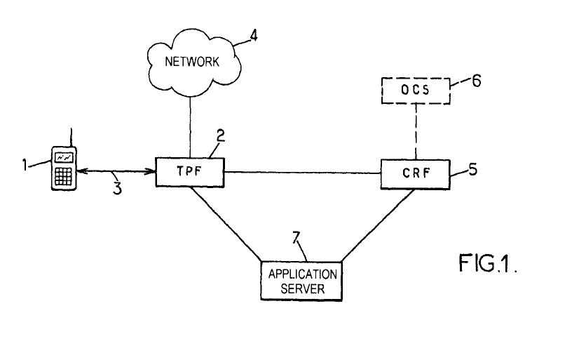

FIG. 1 is a simplified diagram of the architecture of a system in which the invention can be used;

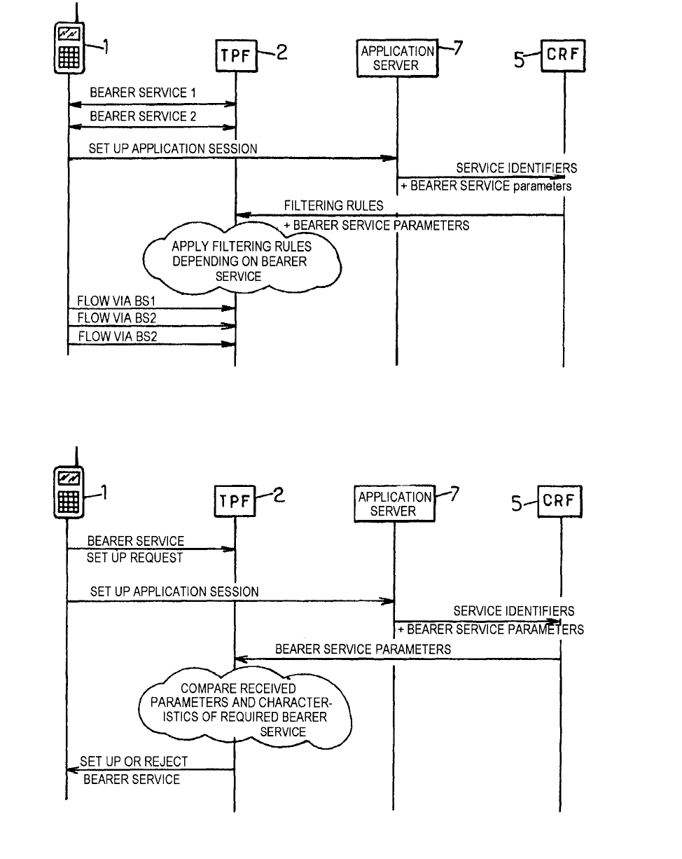

FIG. 2 is a representation of protocol exchanges in accordance with a first embodiment of the invention; and

FIG. 3 is a representation of protocol exchanges in accordance with a second embodiment of the invention.

FIG. 1 shows the simplified architecture of a system in which the invention can be used. A terminal 1 is adapted to communicate with the system represented. Communications involving the terminal 1 are carried by communication means 3 of the system represented, which differ depending on the system used. For example, if the system uses a radio communication technology such as the GPRS or UMTS technology, the communication means include a radio access subsystem connected to a core network consisting of meshed switches. If the system uses a cable communication technology, the communication means are chosen to be compatible with that technology. The communication means use communication media to carry communications, for example communication radio resources in a GPRS or UMTS type radio access subsystem and core network resources.

The system further includes a gateway 2 as defined above that manages communications with terminals such as the terminal 1. In particular, communications carried by the communication means 3 are effected using a bearer service set up between the terminal concerned and the gateway 2. If the system uses the GPRS or UMTS communication technology, for example, this bearer service is called PDP context, as indicated above. The PDP context has features relating in particular to the communication media used to effect communications.

The gateway 2 is connected to at least one external network 4 and handles dialogue between, and appropriate formatting of information exchanged between, the communication means 3 and the network 4. If the communication means 3 use the GPRS or UMTS technology, for example, the network 4 can be a data network such as the Internet. In this case the gateway 2 (which is then a GGSN) also includes an IP router function.

The system represented in FIG. 1 further includes an application server 7 that offers terminals one or more application services that can be of any type, for example voice services, data transmission services, web type services, data downloading services, games services, voice over IP transmission services, etc.

If the terminal 1 wishes to use a service offered by the server 7, it can set up a communication carried by the communication means 3 of the system using a bearer service set up with the gateway 2.

The system also includes a traffic plane function (TPF) for selectively processing communications, which is advantageously provided by the gateway 2, although it can equally well be implemented in an equipment unit separate from the gateway. Below, to simplify the explanation, it is considered that this function is provided by the gateway, and the gateway provided with the selective processing function is therefore labeled TPF.

The selective processing function analyzes the communication flows at the TPF 2 with a view to applying appropriate processing to them, this processing possibly differing as a function of the characteristics of the flows. To this end, communication filtering rules can be predefined at the TPF 2. Alternatively, a filter unit 5, called the CRF, and mentioned in the introduction, can contain predefined filtering rules that it can send to the TPF 2.

As explained in the introduction, the filtering rules can include indications identifying a particular flow of communications, such as an IP 5 tuple including at least some of the following information: source IP address, destination IP address, source port number, destination port number, protocol identifier. The rules can equally include other information such as charging rules, such as a charging key, a charging mode such as charging by volume or by elapsed time, etc.

Once the TPF 2 has these filtering rules, which are supplied to it by the CRF 5, for example, it can apply different processing to certain communication flows corresponding to the specified rules. For example, upon reception of such a rule from the CRF 5, the TPF 2 can apply charging by volume for a communication flow using a voice over IP service offered by the server 7 between the terminal 1 and the identified remote terminal. Of course, other forms of processing are equally possible by means of the architecture shown in FIG. 1, such as statistical analysis of flows exchanged in the system as a function of their characteristics.

Finally, FIG. 1 shows an online charging system (OCS) 6 the function of which is also described in detail in the above-cited technical specification TS 23.125. This is an optional entity that cooperates with the CRF 5 and is used if the filtering rules mentioned above include charging rules. Among other things it defines a credit concept and supplies the TPF 2 with communication authorizations for a given terminal as a function of a remaining credit.

According to the invention, selective processing can be applied to the various communication flows taking account of the bearer services used for the communications. There is therefore a requirement to be able to use different filtering rules for communication flows on separate bearer services relating to services that are identical or have the same characteristics and involve the same terminal.

A first embodiment of the invention described below with reference to FIG. 2 is advantageously implemented in a system of the type shown in FIG. 1. In the example shown, the terminal 1 has two open bearer services in relation to the TPF 2 (“BEARER SERVICE 1” and “BEARER SERVICE 2” in FIG. 2).

If the GPRS or UMTS communication technology is used, this means that two different PDP contexts are set up between the terminal 1 and a GGSN of the system. These PDP contexts can have some characteristics that are common and some characteristics that are different. In particular, each can be adapted to frame communications in accordance with a particular quality of service. The communication media for communications in a given PDP context are then chosen to achieve the specified quality of service. Other characteristics can also be considered.

For example, four traffic classes are generally defined in a PDP context for characterizing the quality of service, each class reflecting a particular traffic behavior in particular in terms of sensitivity to transmission delays. The four classes are called conversational, streaming, interactive, and background and are described in detail, in so far as the UMTS is concerned, in section 6.3 of the technical specification TS 23.107, V5.10.0, “Quality of Service (QoS) concept and architecture”, Release 5, published in September 2003 by the 3GPP.

When a service is to be initiated for the terminal 1, for example at the initiative of the terminal, an application session is first set up between the terminal 1 and the application server 7 that offers the required service. In the application session set-up message, the terminal 1 requests a service from the server 7, to which it supplies certain information. For example, if the target service is a voice over IP service, then the terminal 1 specifies, in addition to its own IP address, the IP address of the remote terminal with which it wishes to communicate. The application session set-up message is sent via the communication means 3 and the TPF 2.

On reception of the application session set-up message, the application server 7 forwards to the CRF 5 the information identifying the service, such as for example the IP address of the terminal 1 and the IP address of the called remote terminal. The server 7 also sends the CRF 5 complementary parameters relating to the service required, which substantially correspond to bearer service characteristics as defined above. For simplicity, these parameters are designated “BEARER SERVICE PARAMETERS” in FIG. 2.

For example, the parameters in question relate to a desirable quality of service for implementing the required service. These parameters can advantageously have a definition identical to, or at least close to, the traffic classes used for the PDP contexts. Accordingly, if the service required by the terminal 1 is a voice service, the application server 7 can indicate to the CRF 5 that the resulting traffic is to be of conversational type, i.e. highly sensitive to transmission delays. Thus the parameters used can embody the four traffic classes referred to above, namely conversational, streaming, interactive, and background. This ensures an easy match between the quality of service provided by the server 7 and the quality of service applied at the bearer service level.

Other parameters can also be considered, for example transmission bit rate, bandwidth, communication coding/decoding mode, transmission delay constraint, or any other parameter for retrieving unambiguously a corresponding bearer service attribute. For example, if the parameter concerned specifies a transmission delay below a given threshold, a corresponding traffic class can then be found at the PDP context level.

Thereafter, the CRF in possession of filtering rules as indicated above informs the TPF 2 of the rules to be applied in respect of the service required by the terminal 1 on the basis of the received service identifiers. For example, a particular charging mode can be specified for the service characterized by the IP addresses of the terminal 1 and the called remote terminal.

Moreover, the CRF 5 forwards corresponding bearer service parameters received from the application server 7 to the TPF 2 with the filtering rules.

Given the nature of the bearer service parameters, upon reception of those parameters, the TPF 2 can then deduce from them the corresponding bearer service characteristics. The TPF 2 then applies the filtering rules received from the CRF 5 to the bearer services as a function of a correspondence between the characteristics of those bearer services and the received parameters. Accordingly, the communication flows transmitted to implement the required service and involving the terminal 1 are then filtered, and where appropriate, processed by the TPF 2 in accordance with the received filtering rules, possibly with a distinction depending on the two open bearer services. This means that a first form of processing can be applied to the flows from the terminal 1 in the context of the bearer service 1 (BS1 in FIG. 2) and a second form of processing can be applied to the flows from the terminal 1 in the context of the bearer service 2 (BS2 in FIG. 2).

An application example is described below with reference to FIG. 2. The context is a system employing the GPRS or UMTS communication technology. It is assumed that the bearer service 1 (or PDP context 1) supports the conversational traffic class and the bearer service 2 (or PDP context 2) supports the streaming traffic class. Moreover, the service required by the terminal 1 from the server 7 is a voice over IP service to a remote terminal and must be implemented with the PDP context 1. Finally, it is assumed that the required service is defined in the CRF 5 as one that has to be charged on the basis of elapsed time.

In the FIG. 2 diagram, the server 7 indicates to the CRF 5 that a voice over IP service from the terminal 1 to a remote terminal is required, specifying the IP addresses of the two terminals. The server 7 further informs the CRF 5 that the voice over IP service requires transmission with a minimum transmission delay, for example by sending it a parameter whose value substantially corresponds to the conversational mode. The CRF 5 forwards this parameter to the TPF 2, also informing it that the service required by the terminal 1 must be charged on the basis of the elapsed time. On receipt of this information, the TPF 2 can then apply the rule received from the CRF 5 selectively, after comparing the characteristics of the PDP contexts open for the terminal 1 and the parameters received from the CRF 5. In this instance, the TPF 2 therefore charges on the basis of the elapsed time the communication flows exchanged with the terminal 1 with the PDP context 1, which is of the conversational type corresponding to the bearer service parameter sent by the CRF 5.

In contrast, if another service offered by the server 7 and having characteristics different from those of the voice over IP service, for example a streaming service, is set up between the same terminals with the PDP context 2, charging will not be based on elapsed time because the filtering rules received from the CRF 5 do not extend to the PDP context 2 that has characteristics that differ from the quality of service indicated in the parameter sent by the CRF 5. It is even possible to apply a different charging mode to flows that are using the PDP context 2, for example charging according to the volume transmitted if the filtering and charging rules specify this.

Note that, according to what has been indicated above, the selective processing achieved in this way can be of different kinds depending on the filtering rules defined in the CRF 5. Although these rules can contain information on the charging to be applied to the communication flows, they can equally serve as a basis for example for a statistical analysis of the flows as a function of the information transmitted. Under such circumstances, the TPF 2 can count the flows that it receives from the terminal as a function of the PDP context with which they are exchanged.

A second embodiment of the invention is described next with reference to FIG. 3 in which the selective processing effected by the TPF 2 is different from that previously described. In this embodiment, the opening of a bearer service is conditional on the type of service considered.

Thus the terminal 1 sends TPF 2 a request to set up a bearer service. The terminal 1 then sends the application server 7 an application session set-up message, as before, with a view to using a service offered by the server 7.

As in the first embodiment of the invention described above, the application server 7 then sends the CRF 5 parameters identifying the required service, for example an IP address of the terminal 1. The server 7 also sends the CRF 5 bearer service parameters as described above as a function of the service required by the terminal 1.

The CRF 5 then forwards these bearer service parameters to the TPF 2. On receipt of those parameters, the TPF 2 deduces the bearer service characteristics to which these bearer service parameters correspond. If the bearer service initially required by the terminal 1 has bearer service characteristics corresponding to the bearer service parameters received from the CRF 5, it means that the required bearer service is able to frame communications according to the service required by the terminal 1. Under such circumstances, the TPF 2 therefore authorizes setting up of the required bearer service and notifies the terminal 1 of this. Otherwise, that is to say if the bearer service initially required by the terminal 1 has bearer service characteristics that do not correspond to the bearer service parameters received from the CRF 5, the TPF 2 refuses to authorize setting up of the required bearer service and notifies the terminal 1 of this.

For example, if the bearer service required by the terminal 1 is a PDP context with a streaming type traffic class, and if the terminal requests from the application server 7 a voice over IP service, which is a service requiring a quality of service supporting very low transmission delays, that is to say a conversational type quality of service to use the terminology employed in connection with PDP contexts, the TFP 2 will reject the setup of the required PDP context. In contrast, if the service required by the terminal 1 requires a streaming type quality of service, for example a video streaming service, the TPF 2 could authorize the setup of the PDP context required by the terminal 1.

It is therefore clear that in this second embodiment the selective processing effected by the TPF 2 consists in authorizing or reject the setup of a bearer service as a function of the service required in the context of that bearer service.

1. A method of controlling communications in a system that includes communication means (3), at least one application server (7), and at least one gateway (2) between the communication means and the application server, which system is adapted to effect communications with terminals in relation to services offered by said application server, and in which system each communication is effected via said communication means using a bearer service between a terminal and said gateway, the method including the following steps in relation to at least one terminal (1) that has at least one communication in progress, or has requested at least one communication, according to a service offered by said application server:
determining in the application server parameters of said service that substantially correspond to respective bearer service characteristics;
sending said determined parameters; and
selectively processing, in the gateway, said communication as a function of said received parameters.

2. A method according to claim 1, wherein said terminal (1) requests a communication in relation to said service using a bearer service to be set up and the selective processing of said communication includes the following steps:
deducing corresponding bearer service characteristics from said parameters sent to the gateway;
comparing the deduced bearer service characteristics with at least some of the characteristics of the bearer service to be setup; and
authorizing the setup of said bearer service to be setup if the comparison reveals that the deduced bearer service characteristics are substantially identical to at least some of the characteristics of the bearer service to be setup, and otherwise rejecting the setup of said bearer service to be setup.

3. A method according to claim 1, wherein the system further includes a filter unit (5) connected to the gateway (2) and to the application server (7), the filter unit being adapted to obtain from the application server indications identifying the service for said communication in progress or said requested communication and to deliver to the gateway rules for filtering communications as a function of said obtained indications, and wherein said determined are transmitted to the gateway via said filter unit.

4. A method according to claim 3, wherein the selective processing of said communication includes the following steps:
receiving at the gateway (2) communication filtering rules corresponding to said determined parameters;
deducing from said determined parameters corresponding bearer service characteristics;
for each of the filtering rules that have been received by the gateway, applying said filtering rule to filter said communication according to the bearer services setup between the terminal and the gateway and having characteristics that are substantially identical to the bearer service characteristics deduced from the parameters received in correspondence with said filtering rule.

5. A method according to claim 4, wherein said communication filtering rules delivered to the gateway include communication charging rules.

6. A method according to claim 4, wherein said indications identifying the service for said communication in progress or said requested communication include one or more of the following: a source IP address, a destination IP address, a source port number, a destination port number, a communication protocol identifier.

7. A method according to claim 1, wherein the parameters that are determined include one or more of the following: a quality of service indication, a class of service, a bandwidth occupied by the service, a coding/decoding mode, a transmission delay constraint.

8. A method according to claim 1, wherein the bearer service characteristics to which the determined parameters substantially correspond include at least on of: a quality of service indication and a traffic class.

9. An application server (7) in a system that further includes communication means (3) and at least one gateway (2) between the communication means and the application server, which system is adapted to effect communications with terminals according to services offered by said application server, and in which system each communication is effected via said communication means using a bearer service between a terminal and said gateway, the gateway being further adapted to selectively process communications as a function of received service parameters, the application server including, in relation to at least one terminal (1) that has at least one communication in progress, or has requested at least one communication, according to a service offered by said application server:
means for determining parameters of said service that substantially correspond to respective bearer service characteristics; and
means for sending said determined parameters to the gateway.

10. An application server (7) according to claim 9, wherein the system further includes a filter unit (5) that is connected to the gateway (2) and to the application server and is adapted to deliver communication filtering rules to the gateway, the application server further including means for transmitting to the filter unit indications identifying the service for said communication in progress or requested, and wherein the means for transmitting said determined parameters to the gateway are implemented via the filter unit.

11. An application server (7) according to claim 10, wherein said indications identifying the service for said communication in progress or requested include one or more of the following: a source IP address, a destination IP address, a source port number, a destination port number, a communication protocol identifier.

12. An application server (7) according to claim 9, wherein said determined parameters include one or more of the following: a quality of service indication, a class of service, a bandwidth occupied by the service, a coding/decoding mode, a transmission delay constraint.

13. An application server (7) according to claim 9, wherein the bearer service characteristics to which said determined parameters substantially correspond include at least one of: a quality of service indication and or a traffic class.

14. A gateway (2) between communication means (3) and at least one application server (7) of a system adapted to effect communications with terminals according to services offered by said application server, each communication being effected via said communication means using a bearer service between a terminal and said gateway, the application server being adapted to determine, for each service offered, parameters that substantially correspond to respective bearer service characteristics,
the gateway including the following steps in relation to at least one terminal (1) that has a at least one communication in progress, or has requested at least one communication, according to a service offered by said application server:
means for receiving the parameters of said service that substantially correspond to respective bearer service characteristics determined by the application server; and
means for selectively processing said communication as a function of said received parameters.

15. A gateway (2) according to claim 14, wherein said terminal (1) requests a communication in relation to said service using a bearer service to be setup, and wherein said means for selectively processing said communication as a function of said received parameters include:
means for deducing corresponding bearer service characteristics from said parameters received by the gateway;
means for comparing the deduced bearer service characteristics with at least some of the characteristics of the bearer service to be setup; and
means for authorizing the setup of said bearer service if the comparison reveals that the deduced bearer service characteristics are substantially identical to at least some of the characteristics of the bearer service to be setup, and for rejecting the setup of said bearer service otherwise.

16. A gateway (2) according to claim 14, wherein the system further includes a filter unit (5) connected to the gateway (2) and to the application server (7), the filter unit being adapted to obtain from the application server indications identifying the service for said communication in progress or requested, the gateway further including means for receiving communication filtering rules delivered by the filter unit as a function of the indications that have been obtained, and wherein the means for receiving said parameters are implemented via said filter unit.

17. A gateway (2) according to claim 16, wherein said means for selectively processing said communication as a function of said received parameters include:
means for receiving communication filtering rules in correspondence with said determined parameters;
means for deducing corresponding bearer service characteristics from said parameters received by the gateway;
means for applying, for each of the filtering rules that have been received by the gateway, said filtering rule to filter said communication according to the bearer services setup between the terminal and the gateway and having at least some characteristics that are substantially identical to said bearer service characteristics deduced from the parameters received in correspondence with said filtering rule.

18. A gateway (2) according to claim 17, wherein said communication filtering rules delivered to the gateway include communication charging rules.

19. A gateway (2) according to claim 17, wherein said indications identifying the service for said communication in progress or requested include one or more of the following: a source IP address, a destination IP address, a source port number, a destination port number, a communication protocol identifier.

20. A gateway (2) according to claim 14, wherein said parameters include one or more of the following: a quality of service indication, a class of service, a bandwidth occupied by the service, a coding/decoding mode, a transmission delay constraint.

21. A gateway (2) according to claim 14, wherein the bearer service characteristics to which the parameters that have been determined substantially correspond include at least one of: a quality of service indication and a class of traffic.

22. A filter unit (5) in a system further including communication means (3), at least one application server (7), and at least one gateway (2) between the communication means and the application server, the system being adapted to effect communications with terminals according to services offered by said application server, each communication being effected via said communication means using a bearer service between a terminal and said gateway, the application server being adapted to determine, for each service offered, parameters that substantially correspond to respective bearer service characteristics,
said filter unit being connected to the gateway (2) and to the application server (7) and including, in relation to at least one terminal (1) that has at least one communication in progress, or has requested at least one communication, according to a service offered by said application server:
means for obtaining from the application server indications identifying the service for said communication in progress or requested;
means for obtaining parameters of said service that substantially correspond to respective bearer service characteristics; and
means for delivering to the gateway rules for filtering communications as a function of said obtained indications in correspondence with said obtained parameters.

23. A filter unit (5) according to claim 22, wherein said communication filtering rules delivered to the gateway include communication charging rules.

24. A filter unit (5) according to claim 22, wherein said indications identifying the service for said communication in progress or requested include one or more of the following: a source IP address, a destination IP address, a source port number, a destination port number, a communication protocol identifier.

25. A filter unit (5) according to claim 22 wherein said determined parameters include one or more of the following: a quality of service indication, a class of service, a bandwidth occupied by the service, a coding/decoding mode, a transmission delay constraint.

26. A filter unit (5) according to claim 22 wherein the bearer service characteristics to which said determined parameters substantially correspond include at least one of: a quality of service indication and a class of traffic.
